(19) United States
(12) Patent Application Publication
(10) Pub. No.: US 2015/0076061 A1
(43) Pub. Date: Mar. 19, 2015

(54) COKING WASTEWATER TREATMENT

(71) Applicants: Chad J. Cai, Suzhou (CN); Jenny Z. Zhang, Shanghai (CN); Zhaohui Yan, Shanghai (CN); Xianrui Wang, Luoyang (CN)

(72) Inventors: Chad J. Cai, Suzhou (CN); Jenny Z. Zhang, Shanghai (CN); Zhaohui Yan, Shanghai (CN); Xianrui Wang, Luoyang (CN)

(73) Assignees: DOW GLOBAL TECHNOLOGIES LLC, Midland, MI (US); ROHM AND HAAS COMPANY, Philadelphia, PA (US)

(21) Appl. No.: 14/347,698

(22) PCT Filed: Nov. 30, 2011
(86) PCT No.: PCT/CN2011/083226

§ 371 Date: Jun. 4, 2014

(51) Int. Cl. C02F 9/00; C02F 1/52; C02F 1/44; C02F 1/42; C02F 3/00

(52) U.S. Cl. CPC C02F 9/00; C02F 1/42; C02F 3/00; C02F 1/441; C02F 1/52; C02F 2103/10
USPC 210/631; 210/665; 210/638

(57) ABSTRACT

A process for treating coking wastewater contains the steps of passing the coking wastewater in such an order through coagulation, particles removal, and ion-exchange resin.

### BACKGROUND OF THE INVENTION

1. Field of the Invention

The present invention relates to a process for treating wastewater generated from coke industry. Particularly, the present invention relates to a process for treating coking wastewater including anion-exchange resin for chemical oxygen demand (“COD”) reduction.

2. Introduction

Coke is a reducing agent widely used in iron industry. China is the largest coke manufacturer and Chinese coke plants generated over 207 million ton of coking wastewater in 2009. Coking wastewater is highly toxic and carcinogenic, and contains many inorganic and organic components including phenolic, aromatic, heterocyclic and polycyclic compounds. Under Chinese National Code GB 13456-92, “Discharge Standard of Water Pollutants for Iron and Steel Industry”, the first class COD discharging limit of coking wastewater is 100 mg/L.

Currently, biological degradation plus coagulation is used to treat coking wastewater in most coke plants. But such a hybrid process can only reduce COD to 300 mg/L, which does not meet even the second class discharging limit (150 mg/L) under GB13456-92. Catalytic oxidation is also used in the treatment. CN101781039A teaches a treatment process including catalytic oxidation, coagulation sediment, ultrafiltration and reverse osmosis. But the oxidation process incurs very high operation cost (OPEX) in order to meet the discharge limit. GB741232 teaches a process including an anion-exchange resin having normal pore size to remove thiocyanate and thiosulphate, an alkali-activated anion-exchange resin having pores that are sufficiently large to permit entry of anions of coloring matter and activated carbon to remove colorants. The alkali-activated anion-exchange resin having large pore size is used as a pre-treatment of the activated carbon. CN101544430A teaches a process for treating coking wastewater including five different ion-exchange resins which reduce COD to 60 mg/L. But the multiple resins processes are complicated and costly in terms of maintenance and regeneration.

It is desirable to develop a process treating coking wastewater to meet the discharge limit at a lower expense.

### BRIEF SUMMARY OF THE INVENTION

Surprisingly, inventors have found a COD reduction process by use of anion-exchange resin and therefore found a process treating coking wastewater. The effluent after such a treatment could meet the discharge limit under Chinese National Code GB13456-92.

In the first aspect, the present invention provides a process for treating coking wastewater comprising the steps of passing the coking wastewater in such an order through coagulation, particles removal, and ion-exchange resin.

Preferably, the inventive process includes the steps of passing the coking wastewater in such an order through coagulation, sedimentation, multi-media filtration, ultrafiltration, strongly basic anion-exchange resin and reverse osmosis.

In the second aspect, the present invention provides a regeneration process regarding the anion-exchange resin used for coking wastewater treatment, said process comprising a step of contacting said resin in such an order with first HCl solution, salt/alkali solution, and second HCl solution.

### DETAILED DESCRIPTION OF THE INVENTION

As used herein:

Unless otherwise stated, all percentages (%) are by weight based on the total weight of a solution or a composition. The descriptions of the various ingredients set forth below are non-limiting.

The units/abbreviations used in the description are illustrated as follows.

| Unit | Full name |
|---|---|
| m | meter |
| μm | micron |
| mm | millimeter |
| m² | square meter |
| m³ | cubic meter |
| MPa | Mega Pascal |
| min | minute |
| h | hour |
| L | liter |
| ml (or mL) | Milliliter |
| ppm | parts per million |
| and/or | and, or as an alternative |

Ion exchange means a reversible chemical reaction where an ion attached to an immobile solid particle is exchanged for a similarly charged ion from a solution. These solid ion exchange particles are either naturally occurring inorganic materials, such as zeolites, or synthesized organic polymers. The synthetic organic polymers are named as ion exchange resin and are widely used in different separation, purification, and decontamination processes today.

Based on the charged mobile ions born by the resin, ion exchange resins can be classified as cation-exchange resins having positively charged mobile ions available for exchange, and anion-exchange resins having negatively charged ions.

A basic anion-exchange resin can release negatively charged ion, such as OH⁻ or Cl⁻, as the exchanged ion and has chemical behaviors like an alkali. The basic anion-exchange resin is preferably a resin having primary, secondary or tertiary amino groups or quaternary ammonium salts as exchange groups. More preferred is a styrenic type, such as styrene/divinylbenzene cross-linked resin. Other preferred resins include acryl/divinylbenzene cross-linked resin and cellulose resin having amino groups as ion exchange groups. Most preferred is a granular resin made of styrene/divinylbenzene cross-linked resin having amino groups as ion exchange groups.

A strongly basic anion-exchange resin is highly dissociated and the exchangeable group (such as OH⁻) is readily available for exchange over the entire pH range. Consequently, the exchange capacity of strongly basic resins is independent of solution pH. Preferably, the strongly basic anion exchange resins are anion exchange resins that contain quaternary ammonium functional groups. Examples of strongly basic anion exchange resins of the present invention include but are not limited to functionalized styrene divinylbenzene or polyacrylic copolymers with a quaternized ammonium functional group. Examples of strongly basic resins of the type used in the present invention can be obtained from The Dow Chemical Company, such as AMBERLITE™ WR60, AMBERLITE™ WR61, AMBERSEP™ WR64, AMBERLITE™ WR™, or AMBERLITE™ WR77 resin. Both AMBERSEP and AMBERLITE are trademarks of The Dow Chemical Company.

Regeneration process is critical to maintain the performance of resins. In the present inventive process, inorganic acid and alkali are used to regenerate the resin. Preferably, three rounds of washing are used: firstly inorganic acid solution is introduced to contact the resin; secondly, a solution of salt and alkali is introduced; thirdly, an inorganic acid solution is introduced. Between two rounds of washing, deionized water (DIW) is introduced to wash the resin. Preferably the inorganic acid solution comprises 0.2-20% inorganic acid, even more preferably 0.5-15% inorganic acid, and most preferably 1-10% inorganic acid. More preferably the salt/alkali solution comprises 0.2-30% salt and 0.2-20% alkali, even more preferably 0.5-25% salt and 0.5-15% alkali, and most preferably 1-20% salt and 1-10% alkali. More preferably, the inorganic acid solution comprises HCl; the salt/alkali solution comprises KCl and/or NaCl and NaOH and/or KOH.

Coagulation (including flocculation) process is primarily used to remove turbidity from the water in wastewater treatment initiated by addition of coagulant chemicals. The reason is that the coagulant chemicals can neutralize the electrical charges born by fine particles in the water, and therefore allow the particles to come closer together and form large clumps and floc. Coagulant chemicals normally includes primary coagulants and coagulant aids. Primary coagulants can neutralize electrical charges born by particles in the water. Coagulant aids can increase density of flocs and as well as toughness to decrease the possibility of breaking up during the following mixing and settling processes.

Coagulant chemicals can be metallic salts, such as ferrous sulfate (FeSO₄.7H₂O), ferric sulfate (FeCl₃.6H₂O), ferric chloride (FeCl₃.6H₂O), alum, calcium carbonate, or sodium silicate; and cationic, anionic, or nonionic polymers.

Particle removal is a treatment process in which suspended particles in the wastewater are removed. Particle removal can be achieved by many forms. In the present invention, preferably particle removal is achieved by sedimentation and/or filtration.

Sedimentation is a treatment process in which the flow rate of the water is lowered below the suspension velocity of the suspended particles and therefore the particles are settled down due to gravity. The process is also named as clarification or settling. Preferably sedimentation follows coagulation (including flocculation) and precedes filtration. Sedimentation here is used to decrease the concentration of suspended particles in the water, reducing the burden of the following filters.

Filtration is a treatment process in which suspended particles are removed from water by passing the water through a medium, such as sand or a membrane. In the present invention, preferably filtration is achieved by multi-media filtration (MMF) and/or ultrafiltration (UF).

Multi-media filtration is conducted by a multi-media filter which includes multiple media, such as activated carbon and quartz sand. For example, the activated carbon is blind coal having a particle size of 0.2-5 mm, preferably 0.5-2 mm, more preferably 0.8-1.2 mm; the quartz sand has a particle size of 0.1-10 mm, preferably 0.3-3 mm, more preferably 0.6-0.8 mm. The multi-media filter can also include other media, such as garnet or resin.

Ultrafiltration is conducted by an ultrafilter which is a membrane filter. Preferably the ultrafilter has a membrane with a pore size of 0.005-0.08 μm, more preferably with a pore size of 0.01-0.05 μm, and most preferably the ultrafilter is in the type of hollow fiber having a PVDF (polyvinylidene fluoride) membrane with a pore size of 0.03 μm.

Preferably, the suspended particles in the wastewater should be reduced to less than 1 ppm before contacting the ion-exchange resin.

Reverse osmosis (RO) is a treatment process in which many types of large molecules and ions are removed from wastewater by a selective RO membrane under pressure. The RO membrane can be made of many materials, and preferably is a polyamide composite membrane. The COD of the effluent from the resin in the inventive process has been lowered and meets the discharging requirement under GB 13456-92. RO is used as a deep treatment following the resin. The effluent of RO can be used as process water, such as recycle condensation water.

Biological treatment is a treatment process in which wastewater is treated by biological digestion of bacteria to lower chemical oxygen demand (COD) and biological oxygen demand (BOD). Normally it can be classified into an anaerobic process and an aeration process. In most cases, both processes are used. Biological treatment can be conducted in a pond or a bioreactor. In the present invention, biological treatment is used as a pre-treatment before the coagulation and other procedures. Preferably the biological treatment used in the present invention is the A2O process (or named A-A/O, Anaerobic-Anoxic-Oxic), such as the process described by Xing Xiangjun et al in “OPERATION MANAGMENT OF A-A/O PROCESS IN COKING WASTE WATER TREATMENT SYSTEM”, Environmental Engineering, Vol 23(2), April, 2005.

Test Method

COD is determined by COD Cr test under Chinese Industry Code HJ/T399-2007, “Water Quality-Determination of the Chemical Oxygen Demand-Fast Digestion-Spectrophotometric Method”.

Static adsorption test is a method to check which resin has better adsorption capability in immobilized wastewater. A candidate resin is put into the wastewater solution for a period of time for adsorption. Based on the COD before and after treatment, the adsorption performance could be evaluated. The process could refer to Example 1 as below.

### Example 1

A comparison test was designed for testing COD removal performance of different ion-exchange resins.

Static adsorption test was run to compare the performance of candidate resins and select the resin that has the highest adsorption capacity to the organics in coking wastewater. 2 ml of each resin were accurately measured and transferred into a 250 ml conical flask with 100 ml of coking wastewater. The flasks were completely sealed and shaken in G25 model incubator shaker (New Brunswick Scientific Co. Inc.) at 130 rpm for 24 hours. Then, COD of the water in the flasks was analyzed.

Five different types of resins were tested in the static adsorption test. The original COD in coking wastewater is 152.3 mg/L. The static adsorption performance is shown in Table 1.

TABLE 1
Static adsorption performance of different type of resins

| | | COD after static | Removal |
|---|---|---|---|
| Model | Type | adsorption, mg/L | efficiency, % |
| AMBERLITE ™ | nonpolar, | 77.4 | 49.2 |
| WR60 | adsorbent | | |
| AMBERLITE ™ | Strongly Basic | 61.1 | 59.9 |
| WR61 | Anion (SBA), | | |
| | acrylic | | |
| AMBERSEP ™ | SBA, styrenic | 20.4 | 86.6 |
| WR64 | | | |
| AMBERLITE ™ | Weakly Basic | 97.7 | 35.9 |
| WR73 | Anion(WBA) | | |
| AMBERLITE ™ | Strongly Acidic | 108.3 | 28.9 |
| WR77 | cation(SAC) | | |

Both AMBERLITE and AMBERSEP are trademarks of The Dow Chemical Company.

It can be seen that the strongly basic anion resin (AMBERSEP™ WR64) achieved the highest COD removal efficiency.

### Example 2

Coking wastewaters from different coking plants in China were passed through filter paper and anion-exchange resin, AMBERSEP™ WR64 (available from The Dow Chemical Company). The test results are listed in Table 2. The adsorption conditions are as follows: fix bed reactor with the ratio of height to diameter 4:1; bed volume 15 ml; adsorption temperature 25° C.; flowrate 6 BV (bed volume)/h. The influent COD is 150 mg/L and 144 BV wastewater was used in each adsorption process.

TABLE 2
Performance of treating coking wastewater from different sources

| | |
|---|---|
| COD, mg/L | Appearance |

| | Influent | Effluent | Influent | Effluent |
|---|---|---|---|---|
| Coking Plant A | 70-160 | ~40 | Brown | Colourless |
| Coking Plant B | 150-200 | ~50 | Brown | Colourless |
| Coking Plant C | 200-300 | ~75 | Brown | Colourless |
| Coking Plant D | 250-300 | ~85 | Brown | Colourless |

It can be seen from Table 2 that anion-exchange resin significantly reduce the COD in coking wastewater from more than 150 mg/L to lower than 100 mg/L and therefore meet the discharge limit under GB13456-92. At the same time, colorants in the wastewater are also removed.

### Example 3

An anion-exchange resin unit (AMBERSEP™ WR64 with a BV of 90L) was under regeneration process. Firstly the resin experienced adsorption process: coking wastewater obtained from Coking Plant E was passed through the resin. The adsorption conditions are as follows: fix bed reactor with the ratio of height to diameter 4:1; bed volume 15 ml; adsorption temperature 25° C.; flowrate 6 BV/h. The influent COD is 150 mg/L and 144 BV wastewater was used in the adsorption process.

Different desorption processes were run at temperature 25-65° C. at a flowrate of 0.1-4 BV/h. Firstly, 0.5-4 BV 1-10% HCl passed through the resin column. Secondly, 0.5-4BV deionized water (DIW) passed through the resin column. Thirdly, 0.5-4 BV salt/alkali (1-20%/1-10%) solution passed through the resin column. Fourthly, 0.5-4 BV DIW passed through the resin column. Fifthly, 0.5-4 BV 1-10% HCl passed through the resin column. At last, 0.5-4 BV DIW passed through the resin column.

Desorption Process 1: Desorption temperature was 25° C., and the flowrate was 0.1 BV/h. Firstly, 0.5 BV 1% HCl passed through the IER column. Secondly, 0.5 BV DIW passed through the resin column. Thirdly, 0.5 BV NaCl/NaOH (1%/10%) solution passed through the resin column. Fourthly, 0.5 BV DIW passed through the resin column. Fifthly, 0.5 BV 1% HCl passed through the resin column. At last, 0.5 BV DIW passed through the resin column.

Desorption Process 2: Desorption temperature was 65° C., and the flowrate was 4 BV/h. Firstly, 4 BV 10% HCl passes through the IER column. Secondly, 4 BV DIW passed through the resin column. Thirdly, 4 BV NaCl/NaOH (20%/1%) solution passed through the resin column. Fourthly, 4 BV DIW passed through the resin column. Fifthly, 4 BV 10% HCl passed through the resin column. Lastly, 0.5 BV DIW passed through the resin column.

Desorption Process 3: Desorption temperature was 45° C., and the flowrate was 1 BV/h. Firstly, 1 BV 5% HCl passed through the IER column. Secondly, 1 BV DIW passed through the resin column. Thirdly, 1BV NaCl/NaOH (15%/5%) solution passed through the resin column. Fourthly, 1BV DIW passed through the resin column. Fifthly, 1 BV 10% HCl passed through the resin column. Lastly, 1 BV DIW passed through the resin column. Desorption Process 4: Desorption temperature was 50° C., and the flowrate was 0.5 BV/h. Firstly, 1 BV 5% HCl passed through the IER column. Secondly, 0.5 BV DIW passed through the resin column. Thirdly, 1 BV NaCl/NaOH (8%/5%) solution passed through the resin column. Fourthly, 3 BV DIW passed through the resin column. Fifthly, 1 BV 5% HCl passed through the resin column. Lastly, 1 BV DIW passed through the resin column.

Desorption Process 5: Desorption temperature was 30° C., and the flowrate was 3 BV/h. Firstly, 1 BV 5% HCl passed through the IER column. Secondly, 1 BV DIW passed through the resin column. Thirdly, 2 BV NaCl/NaOH (10%/10%) solution passed through the resin column. Fourthly, 1 BV DIW passed through the resin column. Fifthly, 1 BV 5% HCl passed through the resin column. Lastly, 1 BV DIW passed through the resin column.

Desorption Process 6: Desorption temperature was 40° C., and the flowrate was 0.5 BV/h. Firstly, 1 BV 5% HCl passed through the IER column. Secondly, 0.5 BV DIW passed through the resin column. Thirdly, 1 BV NaCl/NaOH (10%/3%) solution passed through the resin column. Fourthly, 1 BV DIW passed through the resin column. Fifthly, 2 BV 5% HCl passed through the resin column. Lastly, 1 BV DIW passed through the resin column.

After each desorption process, an adsorption process was repeated as above. The effluent (144 BV in total) COD was analyzed and recorded in Table 3 as below.

TABLE 3
Effluent COD in repeated adsorption process after different desorption processes.

| Desorption | Process 1 | Process 2 | Process 3 | Process 4 | Process 5 | Process 6 |
|---|---|---|---|---|---|---|
| Effluent COD, | 95.6 | 98.4 | 62.3 | 38.5 | 58.1 | 45.7 |
| mg/L | | | | | | |

It can be seen from Table 3 that the resin once treated by Desorption Process 4 obtained the lowest COD in the effluent of the repeated adsorption process, which shows that Desorption Process 4 achieved the best regeneration performance.

### Example 4

In a 2-month trial, 1000 m³ coking wastewater obtained from Coking Plant C and pre-treated by A2O process (Anaerobic-Anoxic-Oxic) was successively passed through coagulation, sedimentation, MINH, UF, anion-exchange resin and RO. Unless otherwise stated, flowrate was kept at 1.0 m³/h. The equipments and operating conductions are listed below.

TABLE 4
Equipment list in the wastewater treating process
Coagulation

| Coagulant | Polymeric Aluminum Chloride (PAC) | |
|---|---|---|
| Dose | 100 | mg/L |

MMF

| | | |
|---|---|---|
| Diameter | Φ750 | mm |

| | |
|---|---|
| Filter materials | Blind coal(particle |
| | size: 0.8~1.2 mm; height: 400 mm) |
| | Quartz sand (particle size: 0.6-0.8 |
| | mm; height: 400 mm) |

UF

| Model | SFP2660, available | |
|---|---|---|
| | from Dow Chemical | |
| Type | Hollow fiber (External pressure) | |
| Membrane material | PVDF | |
| Pore size | 0.03 | μm |
| Area | 33 | m² |
| Inner diameter of fiber | 0.70 | mm |
| External diameter of fiber | 1.30 | mm |
| Operating pH | 2~11 | |
| Operating Temperature | 1~40° | C. |
| Maximum influent Pressure | 0.6 | MPa |

Ion-exchange resin unit

| Resin | AMBERSEP ™ WR64 | |
|---|---|---|
| Bed volume | 90 | L |
| Maximum operating Temperature | 60° | C. |
| Maximum bed depth | 700 | mm |
| Service flow rate | up to 120 BV/h | |
| Feeding rate | 0.5 | m³/h |
| Adsorption cycle time | 24 | h |
| Desorption flowrate | 45 | L/h |
| Desorption operating temperature | 50° | C. |

RO

| Model | BW30-365FR, available | |
|---|---|---|
| | from Dow Chemical | |
| Membrane type | Polyamide composite membrane | |
| Effective area | 34 | m² |
| Flux | 13~24 | L/m²/h |
| Maximum operating Pressure | 4.1 | MPa |
| Highest influent flowrate | 19 | m³/h |
| Highest influent T | 45° | C. |
| Highest influent SDI | 5.0 | |
| Highest influent turbidity | 1 | NTU |
| Residual chlorine | <0.1 | ppm |

| | |
|---|---|
| Operating pH range | 2~11 |
| Chemical rinse pH range | 1~11 |

The coking wastewater was pre-treated by biological treatment and contained COD of 250 mg/L. COD and suspended solid content in the effluents of each unit are listed in Table 5 as below.

TABLE 5
Effluents test results of treating units

| Treating Unit | COD, mg/L | Suspended solid, mg/L |
|---|---|---|
| Biological treatment | 250 | 50 |
| Coagulation sediment | 210 | 10 |
| MMF | 200 | 3 |
| UF | 175 | 0.3 |
| Ion-exchange Resin | 55 | 0.3 |
| RO | 3 | 0.05 |

It can be seen that COD was reduced to lower than 60 mg/L after the treatment of anion-exchange resin.

The operation cost for COD reduction by the inventive anion-exchange resin process (after UF treatment) is much lower compared with oxidation processes, such as about 24% lower than microwave oxidation and Fenton oxidation, and about 48% lower than O₃/BAF (biological aerated filter) oxidation.

What is claimed is:

1. A process for treating coking wastewater comprising the steps of passing the coking wastewater in such an order through
1) coagulation,
2) particles removal, and
3) ion-exchange resin.

2. The process according to claim 1, wherein said ion-exchange resin is anion-exchange resin.

3. The process according to claim 2, wherein said anion-exchange resin is strongly basic anion-exchange resin.

4. The process according to claim 3, wherein said anion-exchange resin is styrenic type.

5. The process according to claim 1, wherein said particles removal is obtained by sedimentation, multi-media filtration, ultrafiltration, or a combination of any of the foregoing.

6. The process according to claim 1, wherein the coking wastewater is pre-treated by biological treatment.

7. The process according to claim 1, further comprising a step of passing the coking wastewater through reverse osmosis.

8. The process according to claim 1, further comprising a step of regenerating said ion-exchange resin, which comprises contacting said resin with the following solutions in such an order:
1) first HCl solution,
2) salt/alkali solution, and
3) second HCl solution.

9. The process according to claim 8, wherein said salt is NaCl or KCl; said alkali is NaOH or KOH.

10. The process according to claim 8, wherein said salt/alkali solution comprises 1-20% salt and 1-10% alkali by weight based on the total weight of said solution.

11. The process according to claim 8, wherein said first HCl solution and said second HCl solution separately comprise 1-10% HCl by weight based on the total weight of said solution.
